(19) United States
(12) Patent Application Publication
(10) Pub. No.: US 2001/0045758 A1
(43) Pub. Date: Nov. 29, 2001

(54) Vehicle cover

(76) Inventor: Joao-Eduardo Vieira-Soares, Chicago, IL (US)

Correspondence Address: Matthew J. Peirce, Esq., 1550 Starlight Canyon Avenue, Las Vegas, NV, 89123, US

(21) Appl. No.: 09/867,992

(22) Filed: May 25, 2001

Related U.S. Application Data
(60) Provisional application No. 60/206,813, filed on May 25, 2000.

(51) Int. Cl. B60J 11/00

(52) U.S. Cl. 296/98; 296/136

(57) ABSTRACT

A new and improved automobile cover is disclosed which can be rolled up into a rear-mounted roll when not in use. The actual roll used with the present invention would be stored inside the trunk of the vehicle, but would have an outlet which would allow the cover to be pulled over the entire vehicle, even when the trunk of the vehicle would be shut. The front edge of the cover would have hooks or other attachment means which would allow the cover to fixedly attach to the bottom of the front bumper. The underside of the cover would also have several Velcro patches, which would allow the cover to removably fasten to various Velcro patches which would be attached to the vehicle in strategic, yet hidden, places.

### I. BACKGROUND OF THE INVENTION

The present invention concerns that of a new and improved automobile cover roll which can be rolled up into a rear-mounted roll when not in use.

### II. DESCRIPTION OF THE PRIOR ART

U.S. Pat. No. 5,176,421, issued to Fasiska, discloses a cover system for an automobile which includes a flexible cover, preferably of nylon, having leading, trailing, and side edge portions and of a suitable dimension to fit over the entire car body from the rear bumper to the front bumper and sides thereof.

U.S. Pat. No. 5,086,988, issued to LaPoint et al., discloses a car cover storage device for allowing easy, quick and convenient storage of a car cover.

U.S. Pat. No. 5,078,330, issued to Hall, discloses a battery powered electric motor driven rewinding and storing apparatus for flexible protective covers for vehicles.

U.S. Pat. No. 4,834,446, issued to Tung-Chow, discloses a packing and storing device for a flexible road vehicle cover which comprises a container having an opening through which the cover can be drawn, a drainage gutter in the lower end of the container leading to a drain hole, a rotatable carrier for the cover mounted in the container and a flexible hose connected to the drain hole.

### III. SUMMARY OF THE INVENTION

The present invention concerns that of a new and improved automobile cover which can be rolled up into a rear-mounted roll when not in use. The actual roll used with the present invention would be stored inside the trunk of the vehicle, but would have an outlet which would allow the cover to be pulled over the entire vehicle, even when the trunk of the vehicle would be shut. The front edge of the cover would have hooks or other attachment means which would allow the cover to fixedly attach to the bottom of the front bumper. The underside of the cover would also have several Velcro patches, which would allow the cover to removably fasten to various Velcro patches which would be attached to the vehicle in strategic, yet hidden, places.

There has thus been outlined, rather broadly, the more important features of a automobile cover in order that the detailed description thereof that follows may be better understood and in order that the present contribution to the art may be better appreciated. There are, of course, additional features of the automobile cover that will be described hereinafter and which will form the subject matter of the claims appended hereto.

In this respect, before explaining at least one embodiment of the automobile cover in detail, it is to be understood that the automobile cover is not limited in its application to the details of construction and to the arrangements of the components set forth in the following description or illustrated in the drawings. The automobile cover is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present automobile cover. It is important, therefore, that the claims be regarded as including such equivalent constructions insofar as they do not depart from the spirit and scope of the present invention.

It is therefore an object of the present invention to provide an automobile cover which has all of the advantages of the prior art and none of the disadvantages.

It is another object of the present invention to provide an automobile cover which may be easily and efficiently manufactured and marketed.

It is another object of the present invention to provide an automobile cover which is of durable and reliable construction.

It is yet another object of the present invention to provide an automobile cover which is economically affordable and available for relevant purchasing government entities.

Other objects, features and advantages of the present invention will become more readily apparent from the following detailed description of the preferred embodiment when considered with the attached drawings and appended claims.

### IV. BRIEF DESCRIPTION OF THE DRAWINGS

FIGS. 1 and 2 show a top view and perspective view, respectively, of the present invention.

FIG. 3 shows a side view of an automobile in which the present invention has been installed.

FIG. 4 shows a perspective view of the present invention in use on top of an automobile.

### V. DESCRIPTION OF THE PREFERRED EMBODIMENT

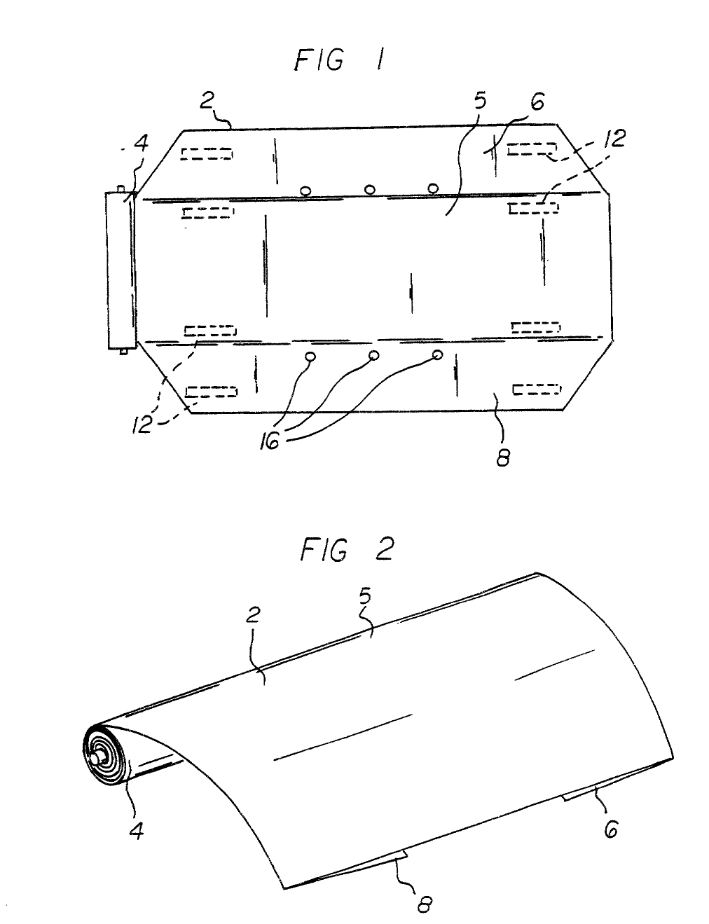

FIGS. 1 and 2 show a top view and perspective view, respectively, of the present invention. Cover 2 can be seen with roll 4. Cover 2 has a front side, a back side, and two end sides, a first end side and a second end side, and also has a top surface and a bottom surface. Cover 2 comprises center portion 5, left side flap 6, and right side flap 8. Center portion 5 is the same width as roll 4, while left side flap 6 and right side flap 8 generally fold over center portion 5 while cover 2 is rolled around roll 4, and at the same time, left side flap 6 and right side flap 8 are unfolded once cover 2 is rolled off of roll 4.

The bottom side of cover 2 includes a plurality of Velcro patches 12, which are strategically placed. Each Velcro patch 12 would be designed to attach to one of several Velcro patches 14, which would be located on a vehicle 18 in a strategic, yet hidden, place. The fact that Velcro patches 14 would be hidden would allow the attachment means to exist, while at the same time, not detracting from the overall look of vehicle 18 by remaining hidden.

Cover 2 also includes a plurality of air holes 16 located on cover 2. Air holes 16 would allow air located underneath cover 2 to escape and would also allow vehicle 18 under cover 2 to properly vent.

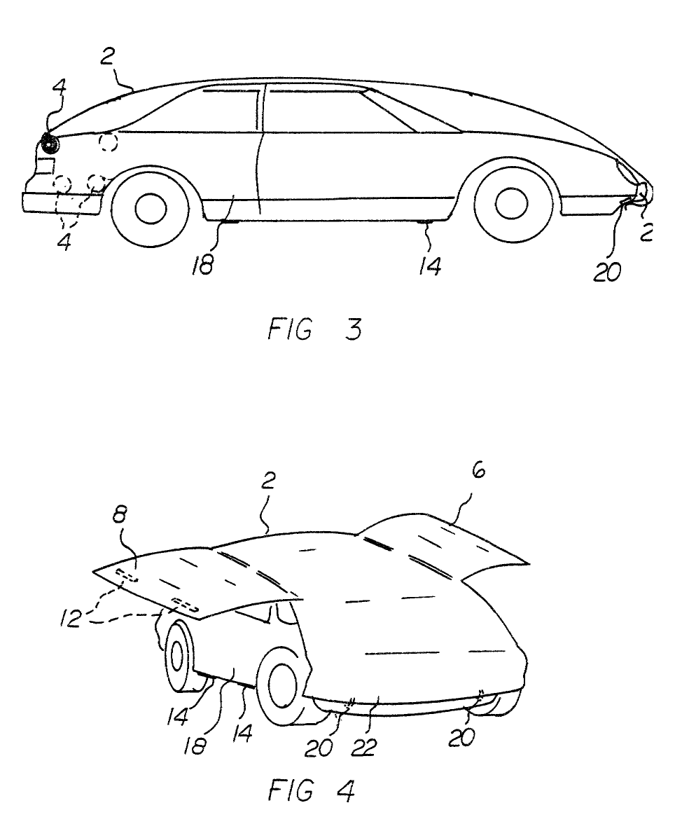

FIG. 3 shows a side view of vehicle 18 in which the present invention has been installed. As can be seen, roll 4 is mounted in the trunk, yet at the same time, cover 2 can be unraveled from roll 4 while the trunk on vehicle 18 is shut. Cover 2 has front-mounted hooks 20 on its front edge, which would allow cover 2 to be securely yet removably fastened to the underside of front bumper 22 of vehicle 18.

FIG. 4 shows a perspective view of the present invention in use on top of an automobile. In this diagram, cover 2 has been securely yet removably fastened to the underside of front bumper 22 of vehicle 18 with use of front-mounted hooks 20. The next step which would need to be performed in order to effectively secure cover 2 to vehicle 18 would be for a user to securely fasten left side flap 6 and right side flap 8 with the use of Velcro patches 12 and Velcro patches 14.

Cover 2 would preferably be fabricated from canvas and/or plastic. The present invention would be properly fastened faster than conventional covers. By using the present invention, a user would not need to worry about folding, storage, or the need for extra trunk space that is typically needed for present storage covers.

What I claim as my invention is:

1. An apparatus for covering a vehicle comprising:
(a) a vehicle, the vehicle including a trunk, the vehicle also including a front-mounted bumper,
(b) a roller mounted axially within the trunk of the vehicle,
(c) a flexible cover having two edges, a front edge and a rear edge, the rear edge of the cover being fixedly attached to the roller, the cover further having two end sides, a first end side and a second end side, the cover further having two surfaces, a top surface and a bottom surface, the cover comprising three sections, a center section, a left side flap section, and a right side flap section, the center section being the same width as the roller, the left side flap section being foldably attached to the first end side, the right side flap section being foldably attached to the second end side,
(d) an outlet on the outer surface of the trunk of the vehicle, the outlet having a length equal to or greater than the length of the roller mounted axially within the trunk of the vehicle,
(e) a first attachment means for attaching the front edge of the cover to the front of the vehicle,
(f) a second attachment means for attaching the bottom surface of the cover to the top of the vehicle, and
(g) whereby the cover can be unwound from the roller and used by pulling the cover out of the outlet even when the trunk of the vehicle is closed.

2. An apparatus for covering a vehicle according to claim 1 wherein the first attachment means for attaching the front edge of the cover to the front of the vehicle further comprises
(a) a plurality of hooks, the hooks attached to the front edge of the cover,
(b) the front bumper of the vehicle,
(c) whereby the cover would be unwound from the roller until the cover would envelop the entire vehicle, allowing a user to removably attach the hooks to the front bumper of the vehicle.

3. An apparatus for covering a vehicle according to claim 1 wherein the second attachment means for attaching the bottom surface of the cover to the top of the vehicle further comprises
(a) a plurality of patches part of a hook and loop attachment system which would be attached to the bottom surface of the cover,
(b) a plurality of patches part of a hook and loop attachment system which would be attached to the outside surface of the vehicle,
(c) whereby each patch of a hook and loop attachment system on the bottom surface of the cover would have a corresponding patch of a hook and loop attachment system on the outside surface of the vehicle, allowing each patch on the bottom surface of the cover to be removably attached to the corresponding patch on the outside surface of the vehicle.

4. An apparatus for covering a vehicle according to claim 1 wherein the cover would further include a plurality of air holes, the air holes being interspersed throughout the entire surface area of the cover.
